(19) United States
(12) Patent Application Publication
(10) Pub. No.: US 2015/0177402 A1
(43) Pub. Date: Jun. 25, 2015

(54) PASSIVE MICROSEISMIC RECORD FIRST-BREAK ENHANCEMENT METHOD

(71) Applicant: KING FAHD UNIVERSITY OF PETROLEUM AND MINERALS, Dhahran (SA)

(72) Inventors: ABDULLATIF ABDULRAHMAN SHUHAIL AL-SHUHAIL, DHAHRAN (SA); SANLINN ISMAIL IBRAHIM KAKA, DHAHRAN (SA)

(73) Assignee: KING FAHD UNIVERSITY OF PETROLEUM AND MINERALS, Dhahran (SA)

(21) Appl. No.: 14/139,540

(22) Filed: Dec. 23, 2013

(51) Int. Cl. G01V 1/36; G01V 1/42

(52) U.S. Cl. CPC G01V 1/36; G01V 1/42

(57) ABSTRACT

The passive microseismic record first-break enhancement method accepts a manually picked microseismic event first break from a raw record and associated pick time. The pick time is then saved as tr. A cross-correlation of all distinct trace pairs of the raw record is performed. Next, the method picks and saves the timing (dti) of the maximum value of the i-th cross-correlation for all i=1, . . . , N. Then, the maxima of the cross-correlations at t=0 are aligned by applying a shift of dti to each i-th cross-correlation. The aligned cross-correlations are then stacked to produce a stacked, aligned cross-correlation that has an enhanced SNR. The enhanced traces are produced by shifting the stacked, aligned cross-correlation by an amount of tm=tr+dtrm, where dtrm indicates the timing of the maximum value of the cross-correlation between the m-th trace and the reference trace.

### BACKGROUND OF THE INVENTION

1. Field of the Invention

The present invention relates generally to passive seismic event detection, and particularly to a passive microseismic record first-break enhancement method that provides an interferometric method of enhancing passive seismic events that includes an algorithm for correlating multiple seismic traces to enhance detection of weak, passive seismic events.

2. Description of the Related Art

Seismic interferometry involves the cross-correlation of responses at different receivers to obtain the Green's function between these receivers. For the simple situation of an impulsive plane wave propagating along the x-axis, the cross-correlation of the responses at two receivers along the x-axis gives the Green's function of the direct wave between these receivers.

When the source function of the plane wave is a transient, as in exploration seismology, or a noise signal, as in passive seismology, then the cross-correlation gives the Green's function convolved with the autocorrelation of the source function.

Direct-wave interferometry also holds for 2-D and 3-D situations, assuming the receivers are surrounded by a uniform distribution of sources. Seismic interferometry (SI) involves cross-correlation (CC) and summation of traces. SI has been used in many applications. Enhancement of weak microseismic (MS) events has, however, remained problematic.

Thus, a passive microseismic record first-break enhancement method solving the aforementioned problems is desired.

### SUMMARY OF THE INVENTION

The passive microseismic record first-break enhancement method accepts a manually picked microseismic event first break from a raw record and associated pick time. The pick time is then saved as the value of the variable tr. A cross-correlation of all distinct trace pairs of the raw record is performed. Next, the method picks and saves the timing (dti) of the maximum value of the i-th cross-correlation for all i=1, . . . , N. Then the maxima of the cross-correlations at t=0 are aligned by applying a shift of dti to each i-th cross-correlation. The aligned cross-correlations are then stacked to produce a stacked, aligned cross-correlation that has an enhanced signal-to-noise-ratio (SNR). The enhanced traces are produced by shifting the stacked aligned cross-correlation by an amount (tm) of tm=tr+dtrm, where dtrm indicates the timing of the maximum value of the cross-correlation between the m-th trace and the reference trace.

These and other features of the present invention will become readily apparent upon further review of the following specification and drawings.

### BRIEF DESCRIPTION OF THE DRAWINGS

FIG. 1 is a flowchart showing the steps in a passive microseismic record first-break enhancement method according to the present invention.

FIG. 2 is an exemplary zero phase Ricker wavelet plot.

FIG. 3 is a minimum phase wavelet plot.

FIG. 4 is a schematic diagram of an exemplary source-receivers plot showing coordinates for a source of a seismic event and 15 receivers (inside the ellipse) at ground surface level.

FIG. 5 is a normalized raw trace plot showing raw traces generated at the receivers of FIG. 4 using the zero phase wavelet of FIG. 2 after adding noise and after normalization.

FIG. 6 is a normalized raw trace plot showing raw traces generated at the receivers of FIG. 4 using the using the minimum phase wavelet of FIG. 3 after adding noise and after normalization.

FIG. 7 is a cross-correlation plot distinct trace pairs for the raw traces of FIG. 5.

FIG. 8 is a cross-correlation plot distinct trace pairs for the raw traces of FIG. 6.

FIG. 9 is a cross-correlated trace plot for the traces of FIG. 7 after alignment.

FIG. 10 is a cross-correlated trace plot for the traces of FIG. 8 after alignment.

FIG. 11 is a stacked cross-correlated trace plot for the traces of FIG. 9.

FIG. 12 is a stacked cross-correlated trace plot for the traces of FIG. 10.

FIG. 13 is a plot of the stacked cross-correlated traces of FIG. 11 after being shifted.

FIG. 14 is a plot of the stacked cross-correlated traces of FIG. 12 after being shifted.

FIG. 15 is a raw microseismic data record plot from an oil field in the Middle East using 14 receivers in the borehole without additive noise.

FIG. 16 is the raw microseismic data record plot of FIG. 15 after adding Gaussian random noise to the traces, the manually picked microseismic event being shown by the arrow on the sample line of the plot.

FIG. 17 is a cross correlation plot of all distinct trace pairs of the noisy raw record of FIG. 16.

FIG. 18 is a plot showing alignment of cross-correlations by shifting their maxima to t=0.

FIG. 19 is a plot of the aligned cross-correlations of FIG. 18 after being stacked.

FIG. 20 is a comparison plot between the aligned cross-correlation of the 45th trace pair and the stacked aligned cross-correlation of FIG. 18.

FIG. 21 is an enhanced record plot produced by shifting the stacked aligned cross-correlation of FIG. 19 to the correct first-break timings derived from trace cross-correlations and one manual pick on trace 1.

FIG. 22 is a plot showing a comparison between the enhanced and raw records before adding noise.

FIG. 23 is a plot showing a comparison between the first trace of the enhanced and raw records before adding noise.

FIG. 24 is a plot showing a comparison between enhanced and raw records after adding noise.

FIG. 25 is a plot showing a comparison between the first trace of the enhanced record vs. the raw record with added noise.

Similar reference characters denote corresponding features consistently throughout the attached drawings.

### DETAILED DESCRIPTION OF THE PREFERRED EMBODIMENTS

At the outset, it should be understood by one of ordinary skill in the art that embodiments of the present method can comprise software or firmware code executing on a computer, a microcontroller, a microprocessor, or a DSP processor; state machines implemented in application specific or programmable logic; or numerous other forms without departing from the spirit and scope of the method described herein. The present method can be provided as a computer program, which includes a non-transitory machine-readable medium having stored thereon instructions that can be used to program a computer (or other electronic devices) to perform a process according to the method. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions. The computer program and machine-readable medium together constitute a computer software product, comprising a non-transitory medium readable by a processor, the non-transitory medium having stored thereon a set of instructions for implementing the present method.

The passive microseismic record first-break enhancement method comprises the steps of accepting a manually picked microseismic event first break from a raw record and its associated pick time, and saving the pick time as tr, where tr is the timing of the microseismic event on the raw reference traces. Then, all distinct trace pairs of the raw record are cross-correlated. If the source wavelet of the microseismic event recorded at all receivers is constant; then these cross-correlations should be very similar to each other, except for a time shift due to different inter-receiver offsets. For an input record with M raw traces, there will be N=0.5 M(M+1) distinct trace pairs to cross-correlate. The method proceeds with steps of picking and saving the timing (dti) of the maximum value of the i-th cross-correlation for all i=1, . . . , N. After this, the maxima of the cross-correlations at t=0 are aligned by applying a shift of dti to each i-th cross-correlation. Due to this process, the timing of the maximum value of all aligned cross-correlations will be zero, regardless of the inter-receiver offset. The method proceeds with the step of stacking the aligned cross-correlations to produce a stacked, aligned cross-correlation that has a much better SNR (approximately equal to the square root of N). Note that the timing of the maximum value of this stacked aligned cross-correlation will also be zero. Then, the method continues with producing the enhanced traces by shifting the stacked, aligned cross-correlations by an amount of tm=tr+dtrm, where dtrm indicates the timing of the maximum value of the cross-correlation between the m-th trace and the reference trace (m=1, . . . , M). Due to this process, the timing of the maximum value of the m-th shifted, stacked, aligned cross-correlation will be equal to the timing of the microseismic event on the corresponding m-th raw trace.

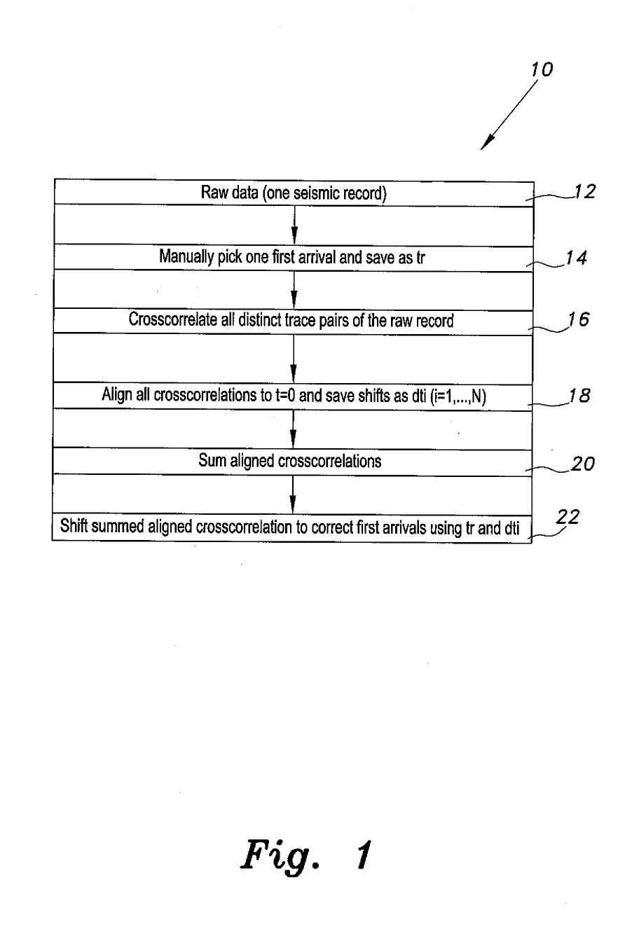

As shown in FIG. 1 the process workflow 10 of the present method involves, getting the raw data, comprising one seismic record (step 12); manually picking a single first arrive and saving the pick as tr (step 14); cross-correlating all distinct trace pairs of the raw record (step 16); aligning all cross-correlations to t=0 and saving shifts as dti (i=1, . . . , N) (step 18); summing the aligned cross-correlations (step 20); and shifting the summed, aligned cross-correlation to correct first arrivals using tr and dti (step 22).

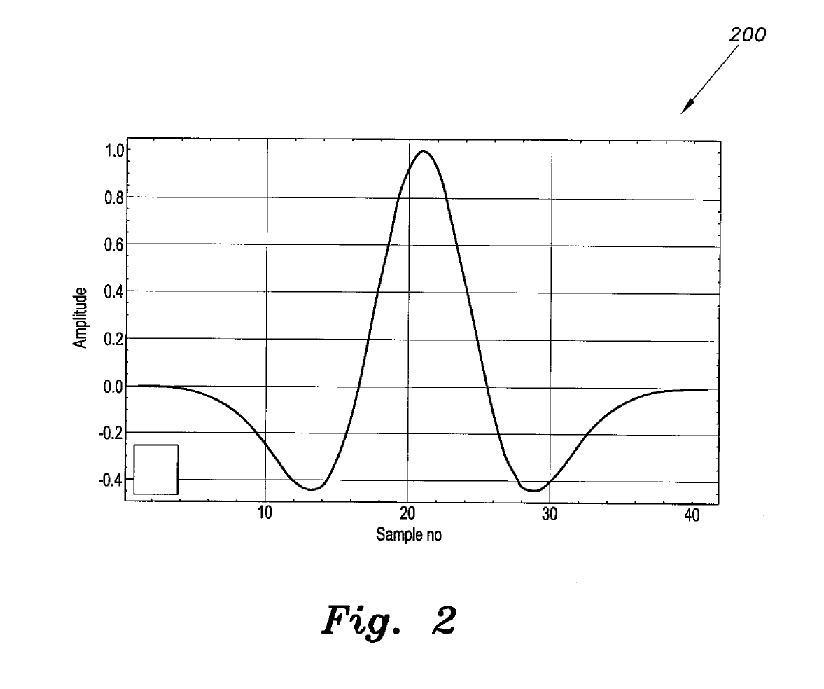

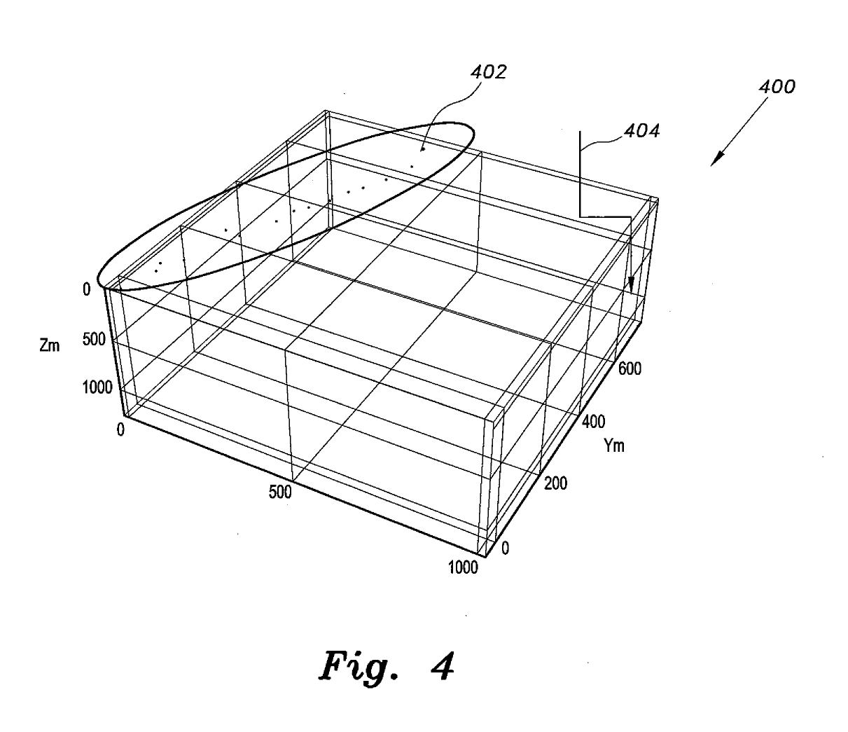

The present enhanced method was tested on synthetic seismic data generated using a source wavelet that is a 5 Hz zero phase Ricker wavelet 200, as shown in FIG. 2. The wavelet 200 had a sampling interval of 10 ms and 300 samples per trace. The source coordinates were xₛ=1000, yₛ=750 m, and zₛ=−1250 m using the coordinate system 400 illustrated in FIG. 4, which also shows fifteen receivers 402 (shown in the ellipse) located on the ground surface with the following coordinates. The reference receiver is the first receiver, with coordinates of xᵣi=0, yᵣi=0, and zᵣi=0. Coordinates of the i-th receiver are found as:

xᵣᵢ=xᵣ₁+i·dxr±R[dxr] (1)

yᵣᵢ=yᵣ₁+i·dyr±R[dyr], and (2)

zᵣᵢ=0, (3)

where dxr=25 m and dyr=50 m, R[dxr] means a random integer in the range ±dxr, R[dyr] means a random integer in the range ±dyr, and M=15. The source coordinates 404 are as indicated in FIG. 4.

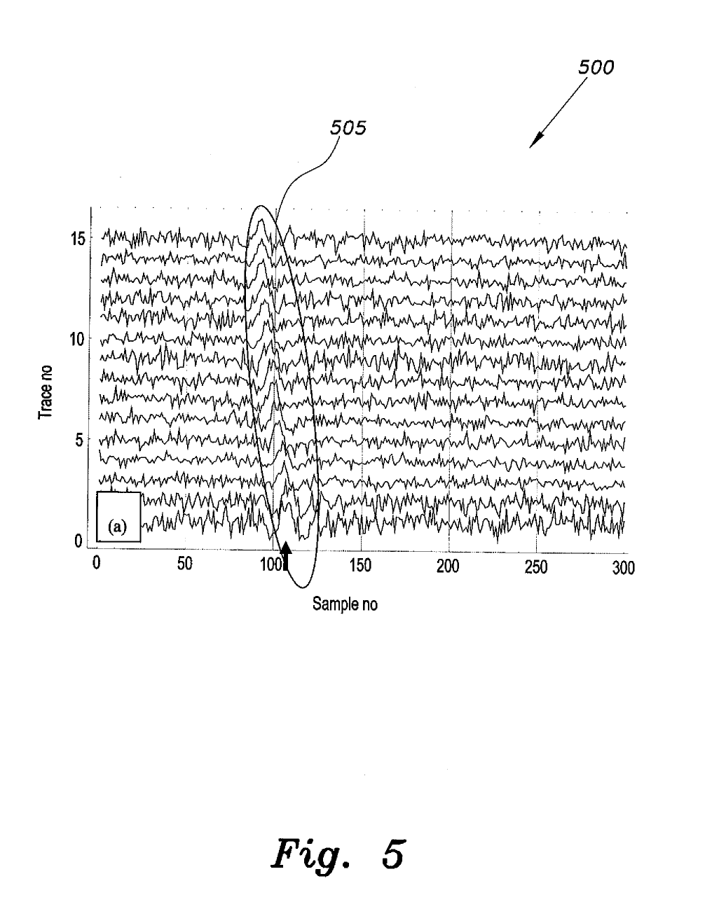

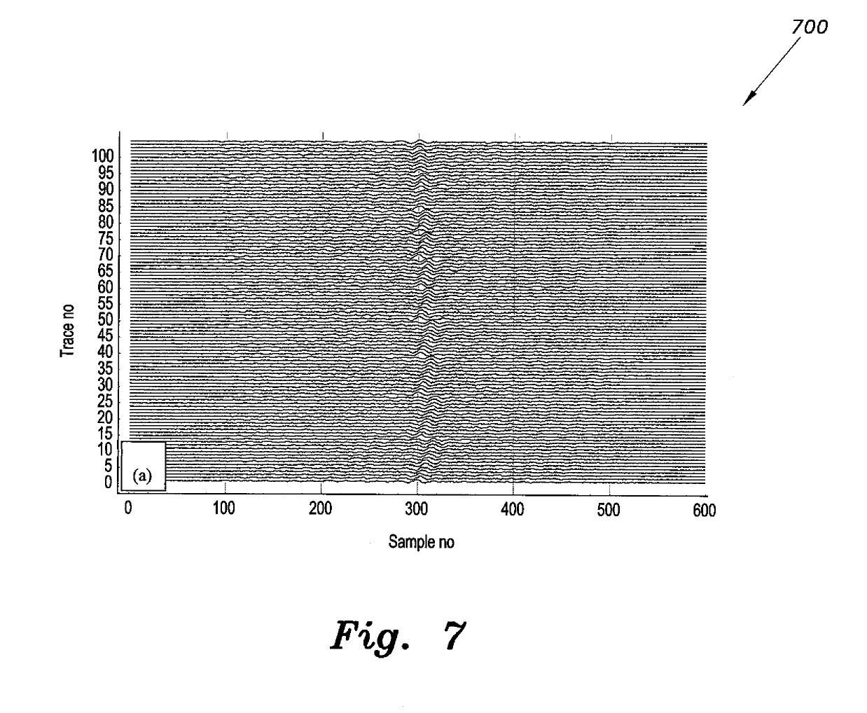

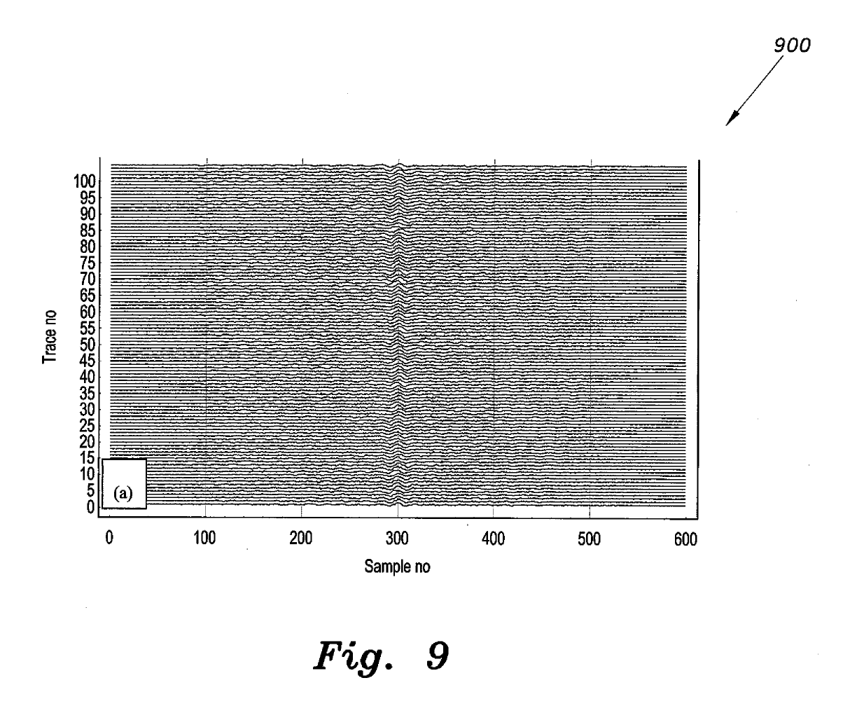

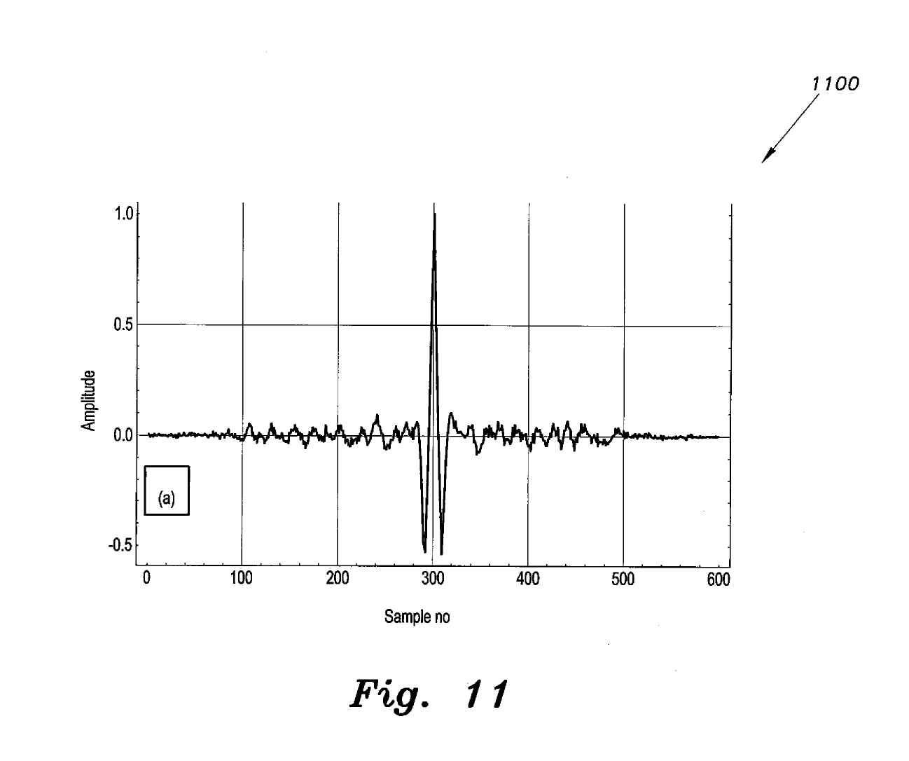

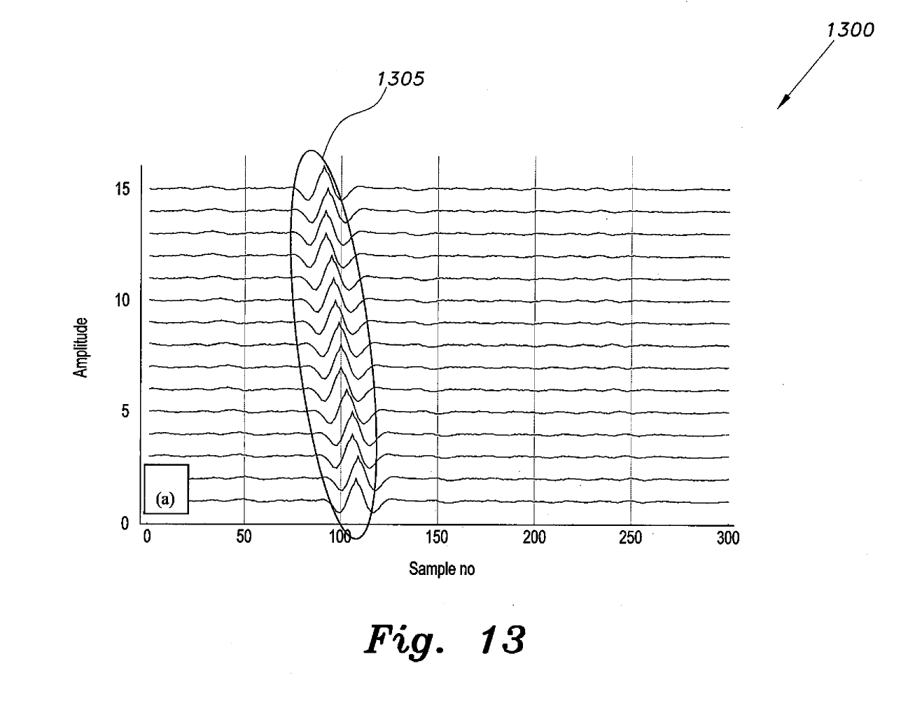

Randomization is used here to simulate slight incorrect receiver positions. Constant medium velocity was 2000 m/s. Raw traces were generated by ray tracing. Plot 500 of FIG. 5 shows the traces after adding Gaussian random noise with zero mean and 0.25 standard deviation to simulate the effects of ambient noise, followed by normalizing each trace by its maximum value. The traces 505 identified by the ellipse are the normalized raw traces generated using the zero phase wavelet. The arrow on the sample line indicates manual pick on the reference first trace (tr=107). FIG. 5 emphasizes the difficulty in picking the passive microseismic event on the raw traces. The zero phase wavelet plots include plot 700 of FIG. 7, plot 900 of FIG. 9, plot 1100 of FIG. 11 and plot 1300 of FIG. 13 which show the raw cross-correlograms, aligned correlograms, stacked aligned correlograms, and the shifted stacked aligned correlograms (enhanced traces), respectively. Comparison of FIGS. 5 and 13 clearly shows the SNR enhancement in the shifted stacked aligned correlogram over the raw traces, which considerably facilitates picking of the event.

Next, the method was tested on another synthetic dataset generated using a normalized minimum phase Berlage wavelet given by the following form:

W(t)=Atⁿe^{-αt} cos(2πft+φ) (4)

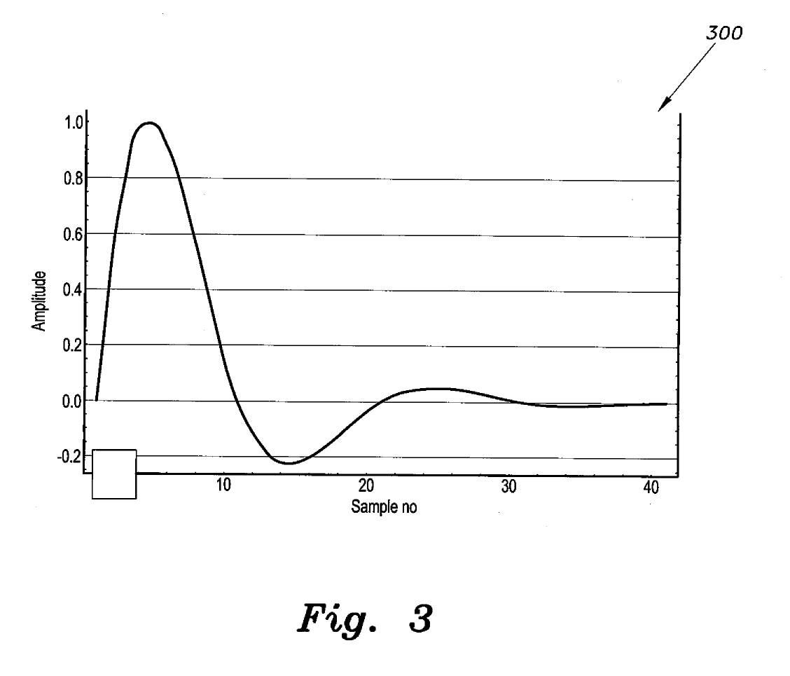

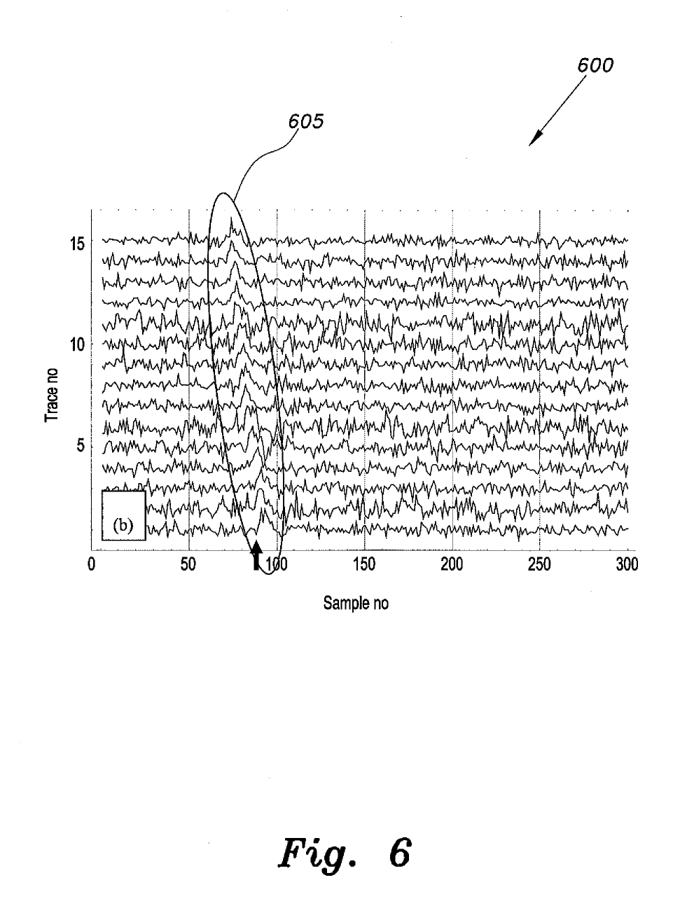

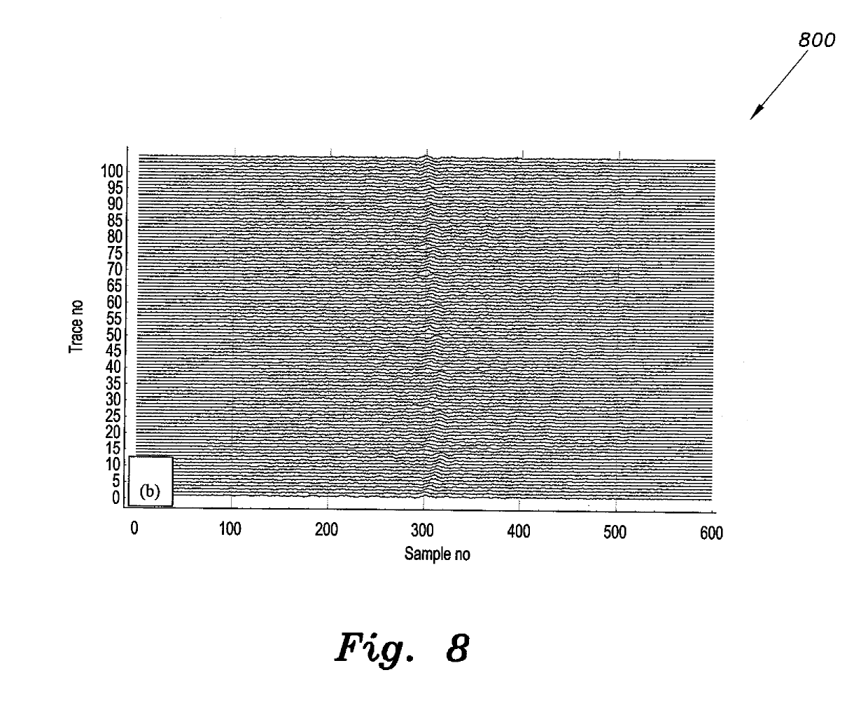

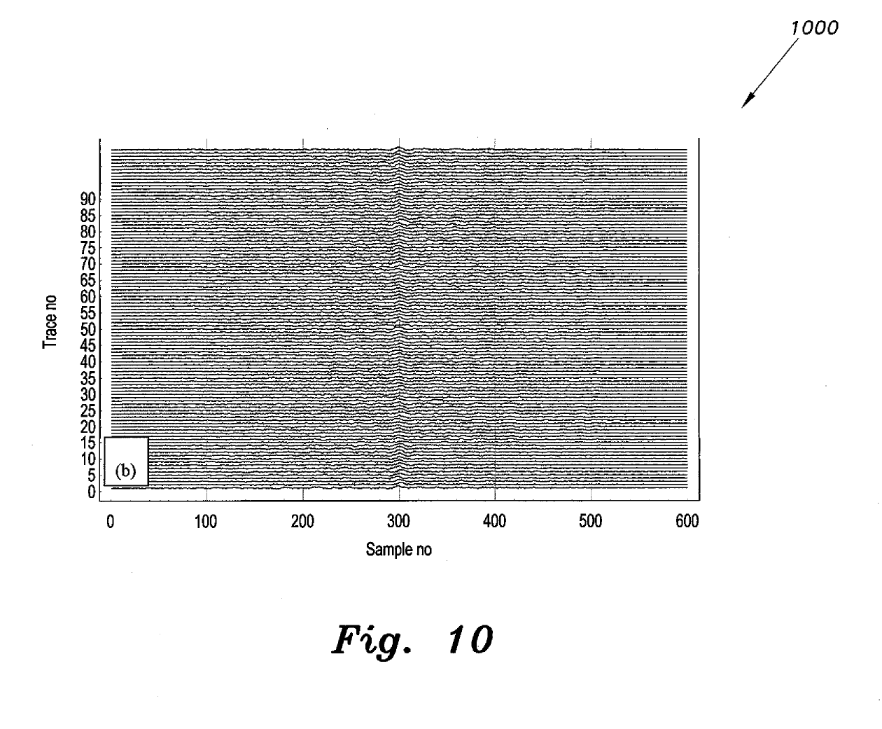

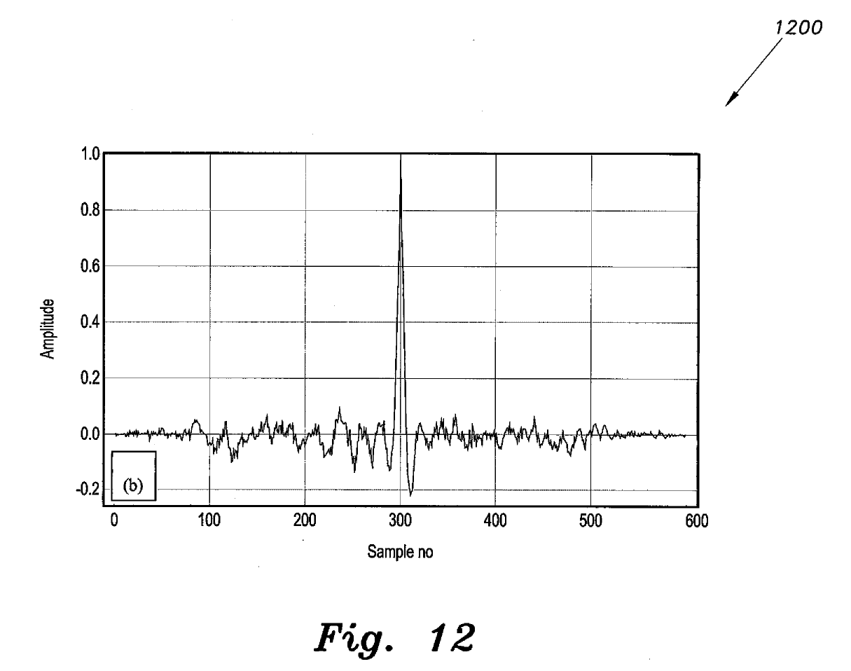

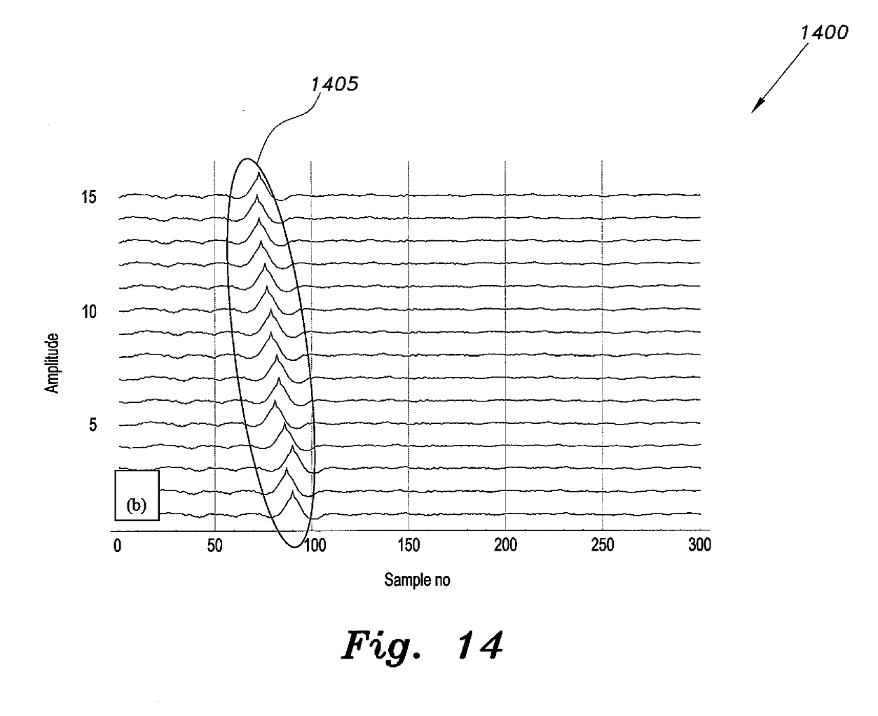

with the parameters: A=1, n=0.001, α=15, f=5 Hz, and φ=π/2. To facilitate comparison with the zero phase case, use the same geometry and parameters for generating the synthetic seismic data. The noise-free wavelet is shown as plot 300 in FIG. 3. FIG. 6 shows the traces after adding the noise and trace normalization. Ellipse 605 indicates the microseismic events. The normalized raw traces were generated using the minimum phase wavelet. The arrow on the sample line indicates manual pick on the reference first trace (tr=88). FIG. 6 emphasizes the difficulty in picking the passive microseismic event on the raw traces. The minimum phase wavelet plots include plot 800 of FIG. 8, plot 1000 of FIG. 10, plot 1200 of FIG. 12 and plot 1400 of FIG. 14, which show the raw cross-correlograms, aligned correlograms, stacked aligned correlograms and the shifted stacked aligned correlograms (enhanced traces), respectively. Comparison of FIGS. 6 and 14 shows the SNR enhancement in the shifted stacked aligned correlograms over the raw traces, which was also observed for the zero phase synthetic seismic data set. These tests show that the present method enhances passive microseismic events, regardless of the source wavelet phase.

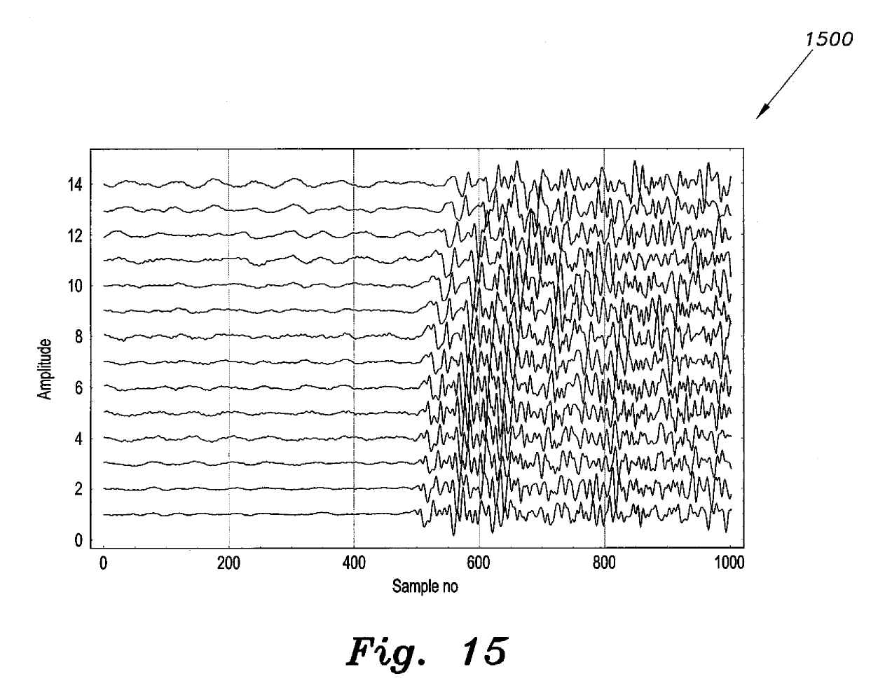

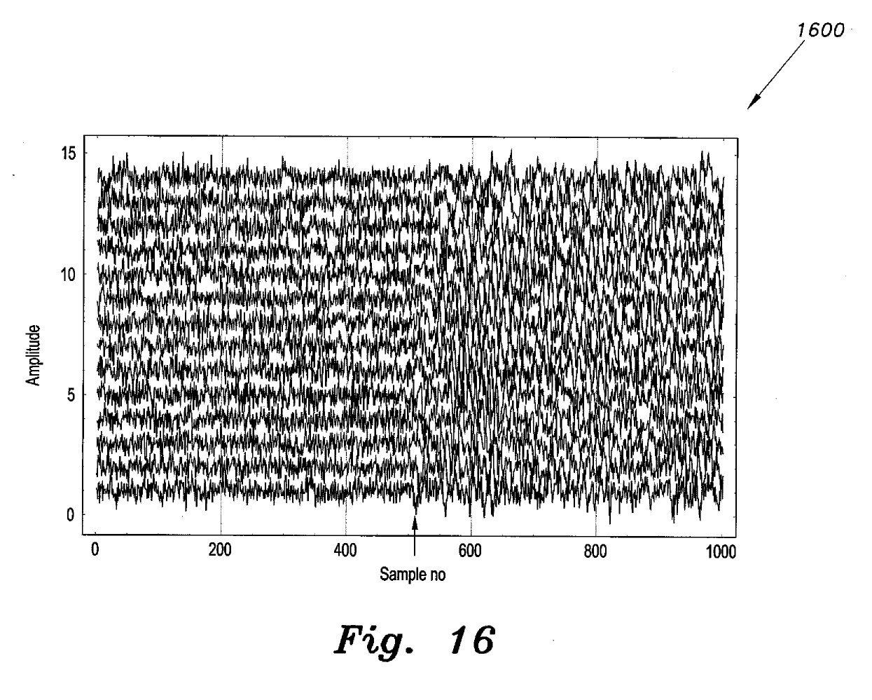

Furthermore, the method was applied on the raw microseismic record shown in plot 1500 of FIG. 15. The data was recorded over a producing oil field in the Middle East in a nearly vertical borehole containing 14 receivers, with trace number 1 recorded by the deepest receiver. The microseismic event originally has a good SNR and did not need first-break enhancement, but Gaussian noise was added high enough to make the first-break picking considerably difficult for automatic pickers, as shown in plot 1600 of FIG. 16. The present method was then applied on this noisy microseismic record by first, manually picking the first break of the microseismic event on the first trace from the raw record and saving the picked time as tr=505 (shown by the arrow on the sample line of plot 1600, FIG. 16).

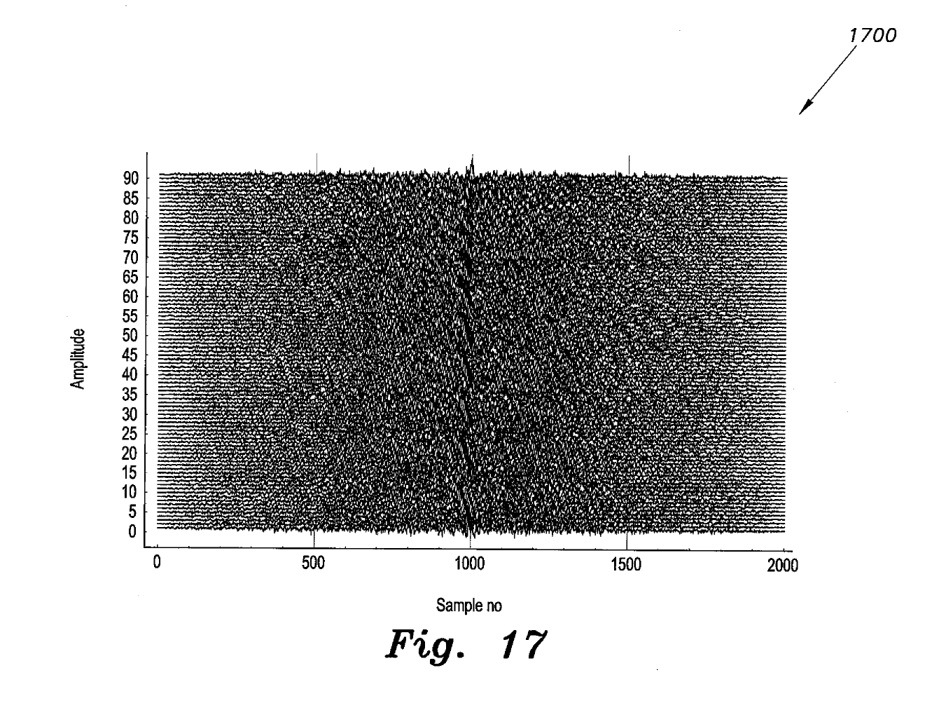

Second, all distinct trace pairs of the raw record are cross-correlated. For input record with M=14 raw traces, there will be N=91 distinct trace pairs to cross-correlate. The resulting cross-correlations are shown in plot 1700 of FIG. 17.

Third, the timing (dtt) of the maximum value of the i-th cross-correlation for all i=1, . . . , 91 are picked and saved.

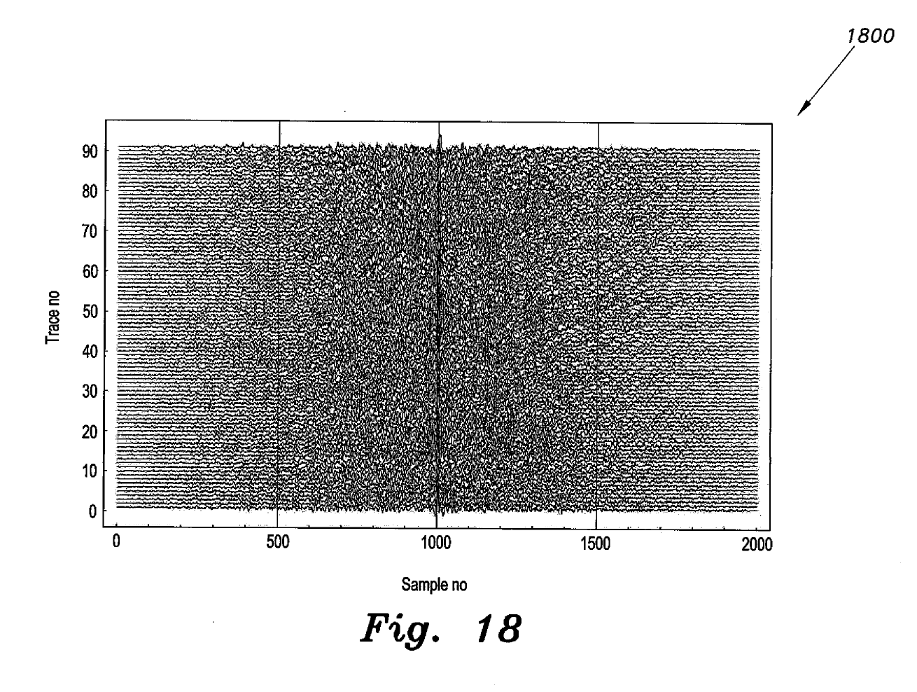

Fourth, the maxima of the cross-correlations at t=0 are aligned by applying a shift of dti to each i-th cross-correlation. The aligned cross-correlations are shown in plot 1800 of FIG. 18.

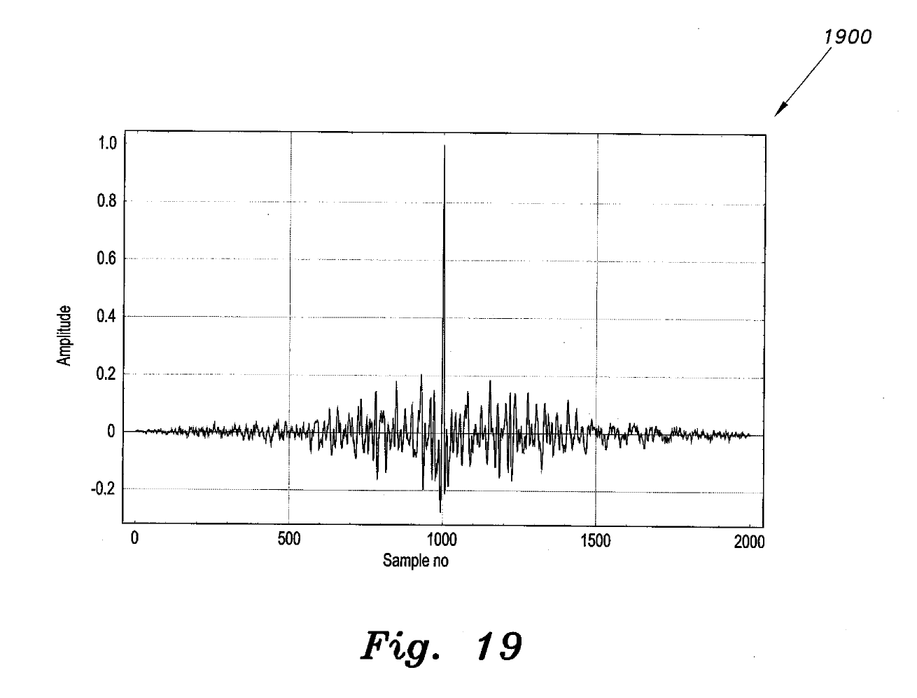

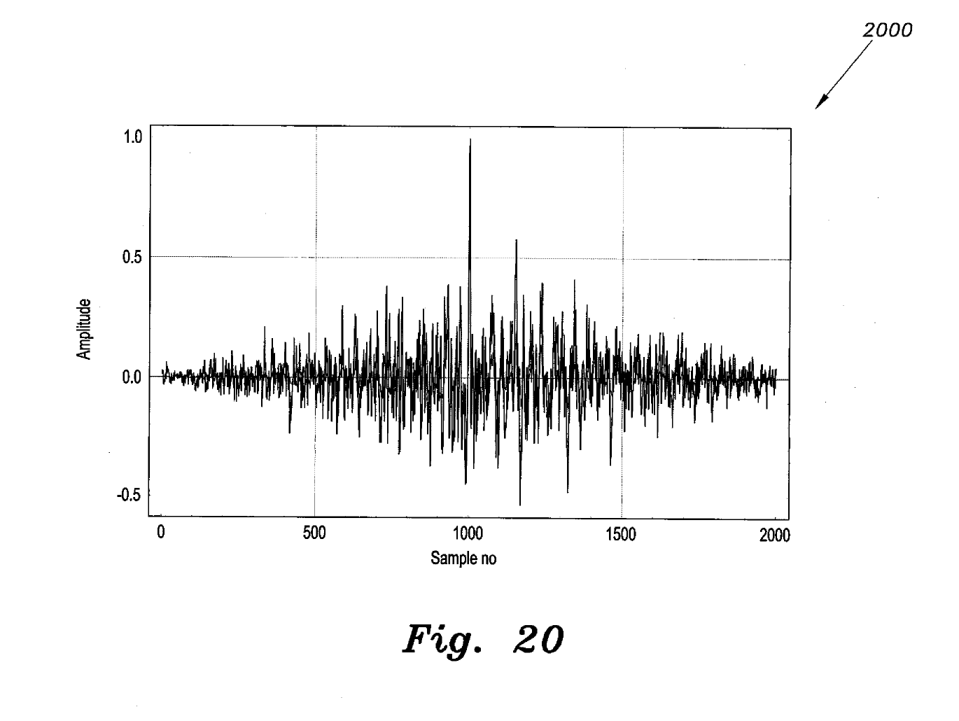

Fifth, these aligned cross-correlations are stacked to produce the stacked, aligned cross-correlation shown in plot 1900 of FIG. 19. Plot 20 of FIG. 20 shows a comparison between the aligned cross-correlation of the 45-th trace pair and the stacked, aligned cross-correlations. The plot is darker where the two cross-correlation types coincide.

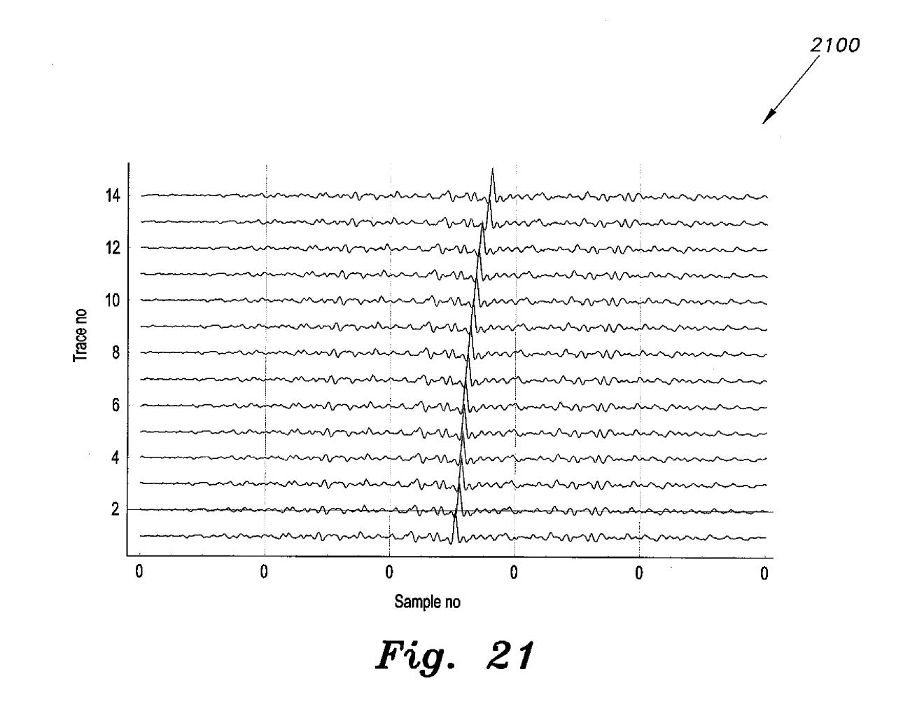

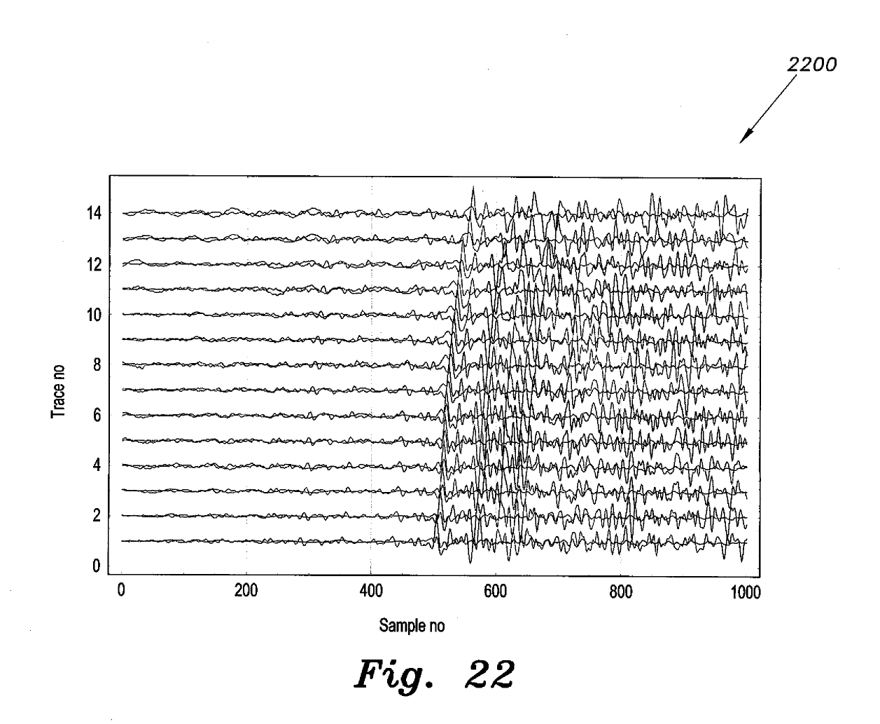

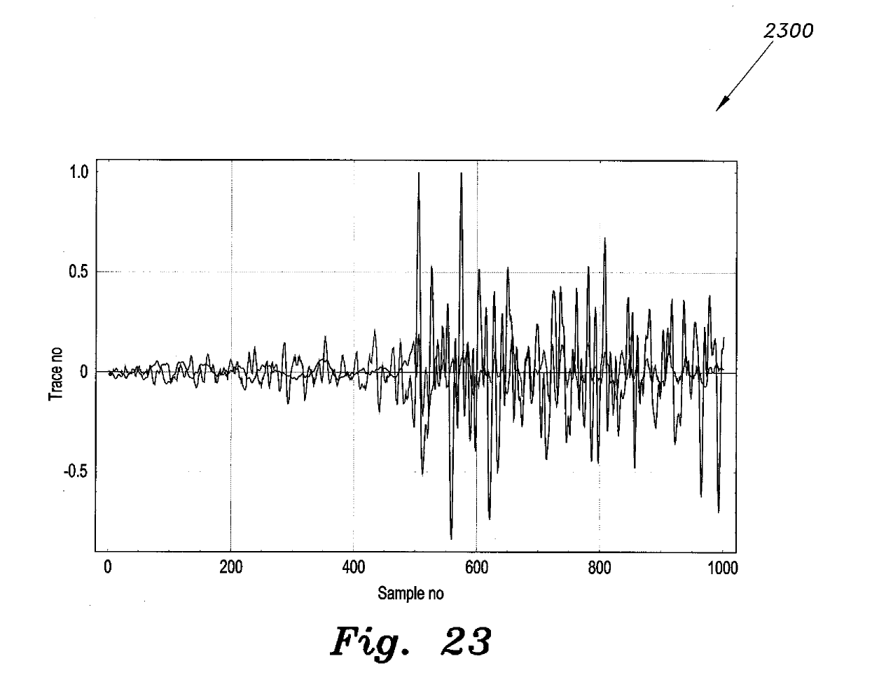

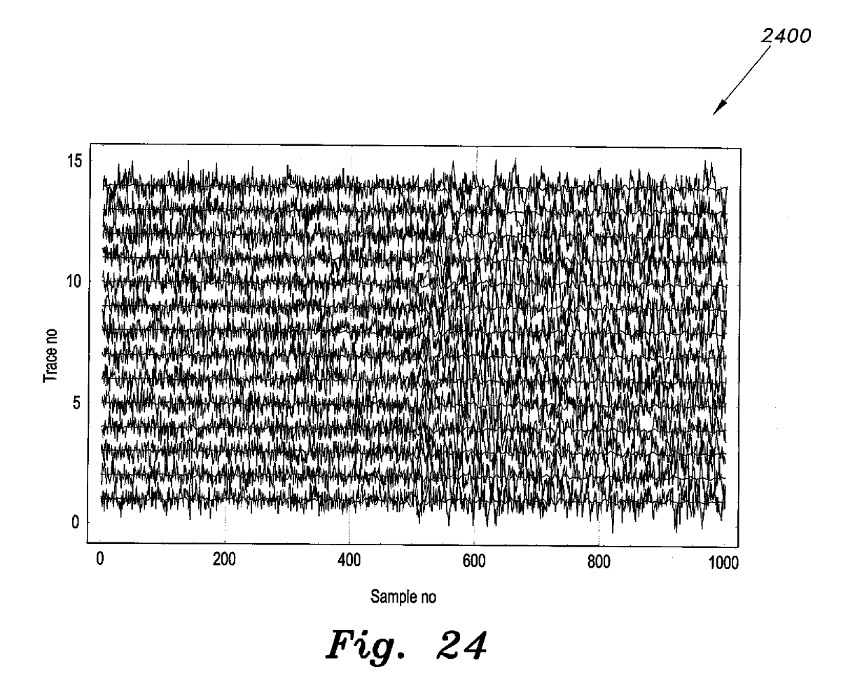

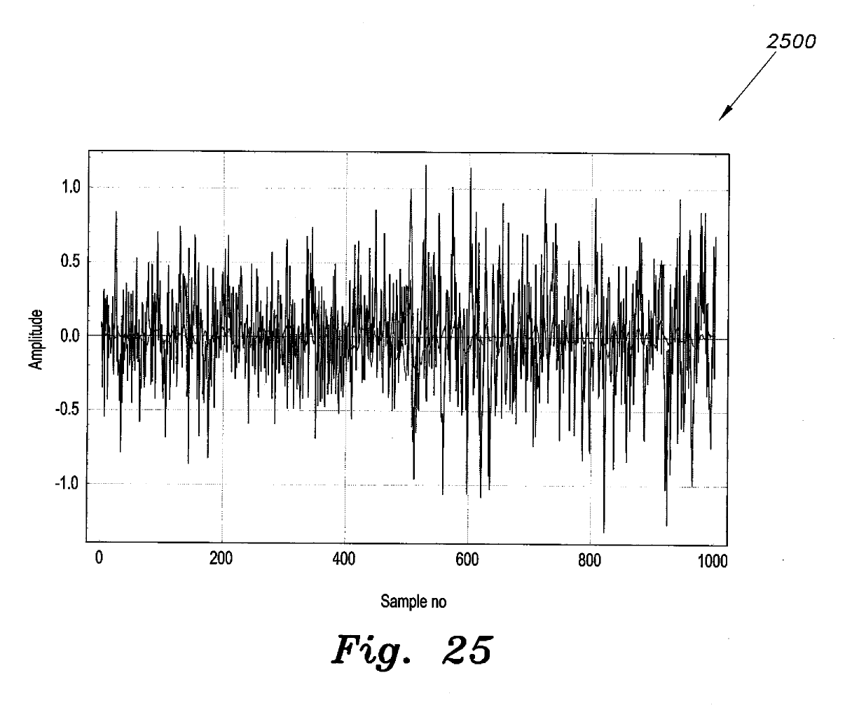

Sixth, the enhanced traces are produced as shown in plot 2100 of FIG. 21 by shifting the stacked, aligned cross-correlations by an amount of tm=tr+dtrm. For benchmarking, plot 2200 of FIG. 22 shows a comparison between the enhanced (darker) and raw (lighter) records before adding noise, while plot 2300 of FIG. 23 shows a comparison between the first trace of the enhanced (darker) and raw (lighter) records before adding noise. Plot 2400 of FIG. 24 shows a comparison between the enhanced (darker) and raw (lighter) records after adding noise, while plot 2500 of FIG. 25 shows a comparison between the first trace of the enhanced (darker) and raw (lighter) records after adding noise.

It can be seen clearly from FIGS. 16 and 21 that the present passive microseismic record first-break enhancement method enhances the first breaks of real microseismic data considerably.

Although the present method avoids re-introducing the noise by convolution, which was observed in previous methods, the current method still introduces a change in the wavelet shape. This is an unavoidable effect of interferometry, since the wavelet has been cross-correlated, which led to replacing the original source wavelet with its auto-correlation. Nevertheless, since most first-arrival picking applications are interested in the relative event timing rather that its amplitude or phase; this change in wavelet shape is practically irrelevant in most applications. However, if phase information is important, one of many standard wavelet shaping techniques can be used to deal with this issue.

The passive microseismic record first-break enhancement method requires only one source record, while existing methods require many source records. Moreover, the present method does not require convolution of the stacked cross-correlation with raw data, which ensures that the raw data does not mix with the enhanced stacked record, and thus can be applied readily to active 2-D and 3-D seismic data. Although the present method requires a manual pick of one first break from the raw data to be entered, nonetheless, this process is not detrimental in most cases, where near-offset traces generally show better SNR than far-offset ones.

It is to be understood that the present invention is not limited to the embodiments described above, but encompasses any and all embodiments within the scope of the following claims.

We claim:

1. A semiautomatic passive microseismic record first-break enhancement method, comprising the steps of:
manually picking a first break from a raw data record of a microseismic event;
saving the manually picked first break with a saved pick time of tr, where tr is the timing of the microseismic event on reference traces extracted from the raw data record;
automatically cross-correlating all distinct trace pairs of the raw data record;
automatically picking and saving the timing (dti) of the maximum value of the i-th cross-correlation for all i=1, . . . , N;
automatically aligning the maxima of the cross-correlations at t=0 by applying a shift of dti to each i-th cross-correlation, thereby nulling an inter-receiver offset effect;
automatically stacking the aligned cross-correlations to produce a stacked, aligned cross-correlation;
and
automatically shifting the stacked, aligned cross-correlation by an amount of tm=tr+dtrm, where dtrm indicates the timing of the maximum value of the cross-correlation between the m-th trace and the reference trace (m=1, . . . , M), thereby producing enhanced traces.

2. A computer software product, comprising a non-transitory medium readable by a processor, the non-transitory medium having stored thereon a set of instructions for implementing a passive microseismic record first-break enhancement method, the set of instructions including:
a first sequence of instructions which, when executed by the processor, causes said processor to accept for processing a manually picked first break from a raw data record of a microseismic event, the manually picked first break having a saved pick time tr, where tr is the timing of the microseismic event on reference traces extracted from the raw data record;
a second sequence of instructions which, when executed by the processor, causes said processor to cross-correlate all distinct trace pairs of the raw data record;
a third sequence of instructions which, when executed by the processor, causes said processor to pick and save timing (dti) of a maximum value of an i-th cross-correlation for all i=1, . . . , N;
a fourth sequence of instructions which, when executed by the processor, causes said processor to align a maxima of the cross-correlations at t=0 by applying a shift of dti to each i-th cross-correlation, thereby nulling an inter-receiver offset effect;
a fifth sequence of instructions which, when executed by the processor, causes said processor to stack the aligned cross-correlations to produce a stacked aligned cross-correlation; and
a sixth sequence of instructions which, when executed by the processor, causes said processor to shift the stacked aligned cross-correlation by an amount of tm=tr+dtrm, where dtrm indicates the timing of the maximum value of the cross-correlation between the m-th trace and the reference trace (m=1, . . . , M), thereby producing enhanced traces.
